(19) United States
(12) Patent Application Publication
(10) Pub. No.: US 2011/0136544 A1
(43) Pub. Date: Jun. 9, 2011

(54) PORTABLE ELECTRONIC DEVICE WITH DATA TRANSMISSION FUNCTION AND DATA TRANSMISSION METHOD THEREOF

(75) Inventors: Chi-Sheng GE, Tu-Cheng (TW); Chen-Huang FAN, Tu-Cheng (TW)

(73) Assignee: HON HAI PRECISION INDUSTRY CO., LTD., Tu-Cheng (TW)

(21) Appl. No.: 12/878,959

(22) Filed: Sep. 9, 2010

(30) Foreign Application Priority Data
Dec. 8, 2009 (CN) 200910311054.9

(51) Int. Cl. G06F 3/041

(52) U.S. Cl. 455/566

(57) ABSTRACT

A data transmission method is applied in a portable electronic device including a touch-sensitive unit. The data transmission method includes: obtaining at least one relative orientation value of at least one external portable electronic device relative to the portable electronic device from a server; determining touched touch points of the touch-sensitive unit and a touch track according to the touched touch points once a touch operation occurs; determining a touch direction value according to the touch track; comparing the touch direction value with the at least one relative orientation value to determine which of the at least one external portable electronic device the portable electronic device will transmit selected data to; and transmitting the selected data to the determined external portable electronic device. A related portable electronic device is also provided.

### BACKGROUND

1. Technical Field

The present disclosure relates to portable electronic devices and, particularly, to a portable electronic device having a data transmission function and a data transmission method thereof.

2. Description of Related Art

Data can be transmitted between portable electronic devices, for example mobile phones, through short distance wireless communication protocols, for example, BLUETOOTH. A conventional method for a portable electronic device to transmit data to another portable electronic device through short distance wireless communication usually includes the following steps: selecting to-be-transmitted data in response to user input; searching for target electronic devices; displaying a list of the found target electronic devices; selecting one of the found target electronic devices; and transmitting the selected data to the selected electronic device. This conventional data transmission method requires that users know in advance the recorded names of electronic devices the selected data should be transmitted to. It is too limiting for a user to be able to select desired electronic devices only when the user know their recorded names in the user's portable electronic device.

### BRIEF DESCRIPTION OF THE DRAWINGS

The components of the drawings are not necessarily drawn to scale, the emphasis instead being placed upon clearly illustrating the principles of a portable electronic device with data transmission function and a data transmission method.

Moreover, in the drawings, like reference numerals designate corresponding parts throughout several views.

FIG. 1 is a schematic view of a data transmission system in accordance with an exemplary embodiment.

FIG. 2 is a schematic view showing position relationship of portable electronic devices of the data transmission system of FIG. 1.

FIG. 3 is a block diagram of a portable electronic device with data transmission function in accordance with an exemplary embodiment.

FIG. 4 is a flowchart of a data transmission method in accordance with an exemplary embodiment.

### DETAILED DESCRIPTION

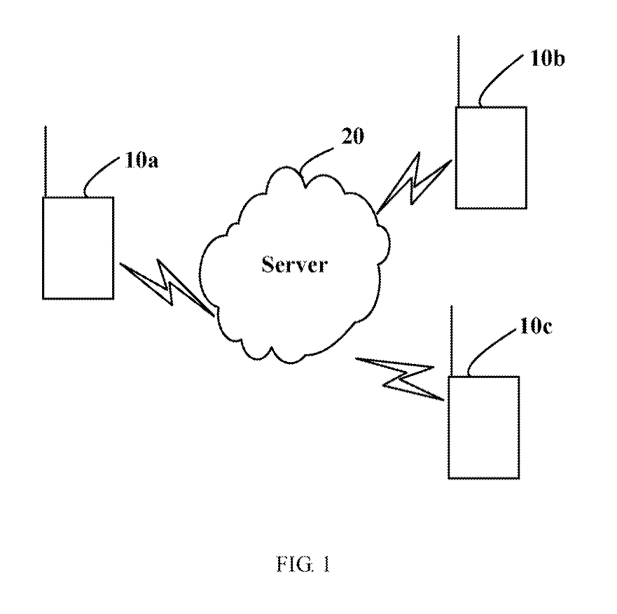

Referring to FIG. 1, an embodiment of a data transmission system is illustrated. The system includes at least two portable electronic devices and a server 20 communicating with the portable electronic devices. The portable electronic devices may be mobile phones, PDAs, or the like. The server 20 can determine the position of each portable electronic device. In an alternative embodiment, each portable electronic device can determine its own position and transmit its own position information to the server 20. The server 20 can further determine relative position between any two of the portable electronic devices according to the positions of the portable electronic devices. The relative position includes distance value and relative orientation value between any two portable electronic devices.

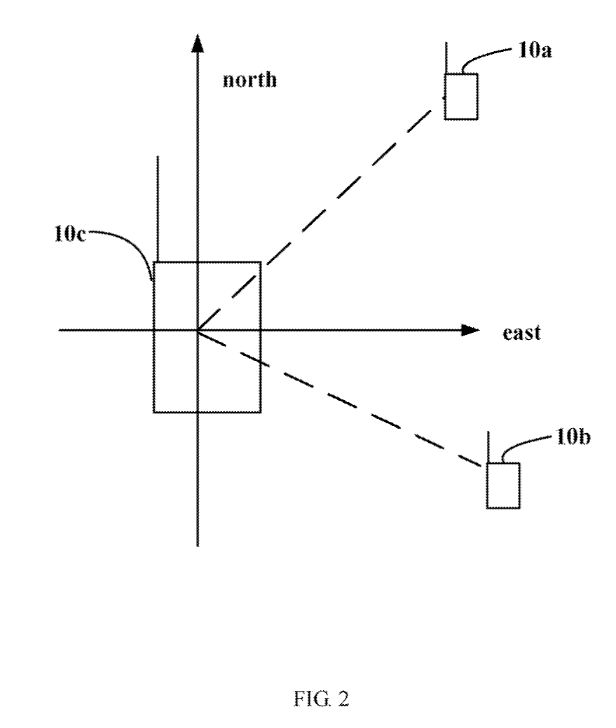

In this embodiment, there are three portable electronic devices 10a, 10b, and 10c, and the portable electronic device 10c is capable of transmitting data to the portable electronic devices 10a, 10b. As shown in FIG. 2, in this embodiment, the portable electronic device 10a locates 45 degrees northeast of the portable electronic device 10c, and the portable electronic device 10b locates 30 degrees southeast of the portable electronic device 10c.

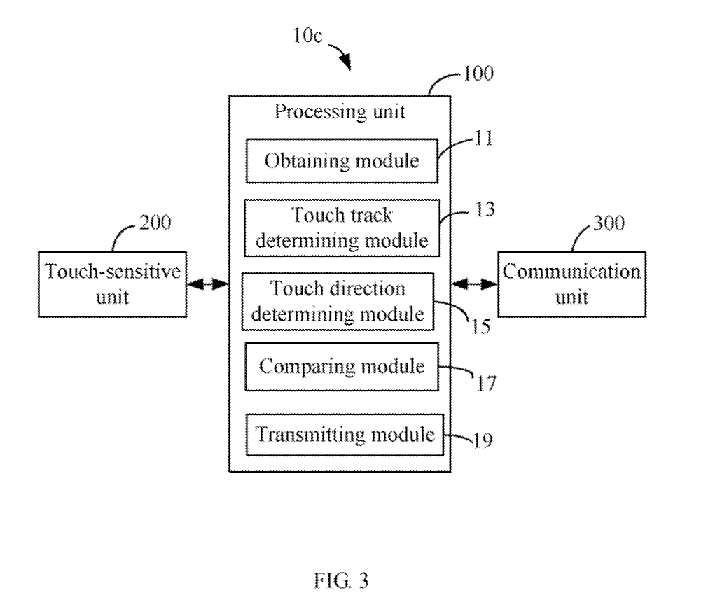

Referring to FIG. 3, the portable electronic device 10c includes a processing unit 100, a touch-sensitive unit 200, and a communication unit 300. The touch-sensitive unit 200 may be a touch-sensitive display or a touch pad. The portable electronic device 10c communicates with the portable electronic device 10a, 10b and the server 20 through the communication unit 300. The communication unit 300 may include at least, for example, a BLUETOOTH unit, an infrared unit, or a WIFI unit.

The processing unit 100 includes an obtaining module 11, a touch track determining module 13, a touch direction determining module 15, a comparing module 17, and a transmitting module 19.

The obtaining module 11 is configured to obtain at least one relative orientation value of at least one external portable electronic device relative to the portable electronic device 10c from the server 20. The obtaining module 11 can be further configured to obtain a distance value between each of the at least one external portable electronic device and the portable electronic device 10c. The obtaining module 11 can be further configured to display a user interface recording the at least one obtained relative orientation value and the at least one obtained distance value on the portable electronic device 10c for a user to view.

The touch track determining module 13 is configured to determine touched touch points of the touch-sensitive unit 200 and determine a touch track according to the touched touch points once a touch operation occurs.

The touch direction determining module 15 is configured to determine a touch direction value according to the touch track. Specifically, the touch direction determining module 15 establishes a Descartes coordinate system. In the coordinate system, the coordinate origin is the starting touch point of the touch track, the X axis extends from west to east, and the Y axis extends from south to north. The touch direction determining module 15 then determines the touch direction value according to the touch track and the Descartes coordinate system. For example, the touch direction value may be northeast 40 degrees.

The comparing module 17 is configured to compare the determined touch direction value with the at least one obtained relative orientation value to determine which of the at least one external portable electronic device the portable electronic device 10c will transmit selected data to. If a difference between the touch direction value and one of the at least one relative orientation value is within a preset value range, and the difference is less than any difference between the touch direction value and any of the remaining of the at least one relative orientation value, the comparing module 17 determines that the portable electronic device 10c will transmit the selected data to the external portable electronic device associated with the one of the at least one relative orientation value. In this embodiment, a difference within the preset value range includes that the difference is equal to any of the lower threshold and the upper threshold of the preset value range. The preset value range may be 0 degree to 15 degrees. If a difference between the touch direction value and one relative orientation value is equal to another difference between the touch direction value and another relative orientation value and the two differences are within the preset value range, the comparing module 17 compares the distance value between the portable electronic device 10c and the external portable electronic device associated with the one relative orientation value with the distance value between the portable electronic device 10c and the external portable electronic device associated with the another relative orientation value, and determines that the portable electronic device 10c will transmit the selected data to the external portable electronic device the distance value between which and the portable electronic device 10c is greater or less. If any difference between the touch direction value and any one of the at least one relative orientation value does not fall within the preset value range, the comparing module 17 determines that the touch operation is an invalid operation, and the portable electronic device 10c does not transmit the selected data to any external portable electronic device.

For example, if the touch direction value is northeast 40 degrees, as the portable electronic device 10a locates 45 degrees northeast of the portable electronic device 10c, and the portable electronic device 10b locates 30 degrees southeast of the portable electronic device 10c, thus the portable electronic device 10c transmits the selected data to the portable electronic device 10a.

The transmitting module 19 is configured to transmit the selected data to the external portable electronic device determined by the comparing module 17 through the communication unit 300.

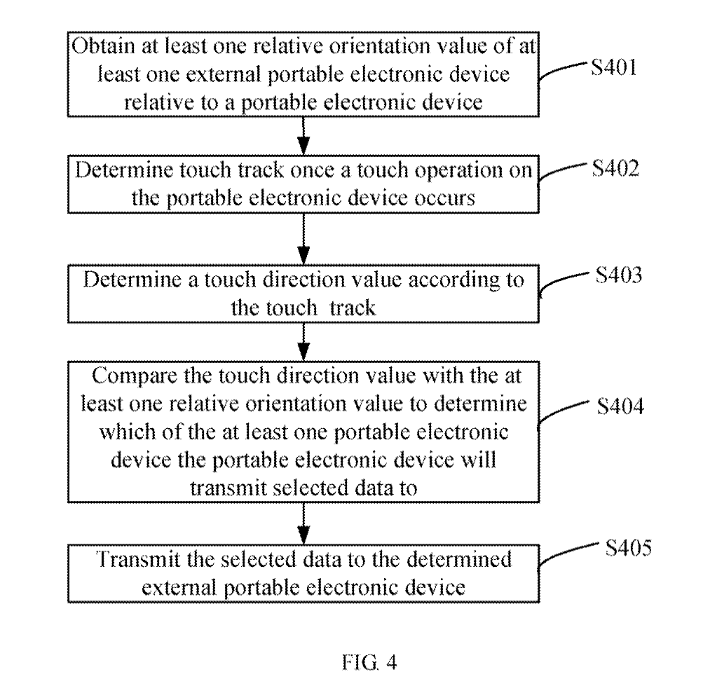

FIG. 4 is a flowchart of a data transmission method in accordance with an exemplary embodiment.

In step S401, the obtaining module 11 obtains at least one relative orientation value of at least one external portable electronic device relative to the portable electronic device 10c from the server 20.

In step S402, the touch track determining module 13 determines touched touch points of the touch-sensitive unit 200 and determines a touch track according to the touched touch points once a touch operation occurs.

In step S403, the touch direction determining module 15 determines a touch direction value according to the touch track.

In step S404, the comparing module 17 compares the touch direction value with the at least one relative orientation value to determine which of the at least one portable electronic device the portable electronic device 10c will transmit selected data to.

In step S405, the transmitting module 19 transmits the selected data to the external portable electronic device determined by the comparing module 17 through the communication unit 300.

Particularly, in step S404, if the comparing module 17 determines any difference between the touch direction value and any one of the at least one relative orientation value does not fall within the preset value range, the comparing module 17 determines that the touch operation is an invalid operation, and the portable electronic device 10c does not transmit the selected data to any external portable electronic device.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A portable electronic device, comprising:
a touch-sensitive unit;
a communication unit; and
a processing unit configured to:
obtain at least one relative orientation value of at least one external portable electronic device relative to the portable electronic device;
determine touched touch points of the touch-sensitive unit and a touch track according to the touched touch points once a touch operation occurs;
determine a touch direction value according to the touch track;
compare the touch direction value with the at least one relative orientation value to determine which of the at least one external portable electronic device the portable electronic device will transmit selected data to; and
transmit the selected data to the determined external portable electronic device.

2. The portable electronic device as described in claim 1, wherein the processing unit's determining the touch direction value according to the touch track comprises: the processing unit establishes a Descartes coordinate system, the coordinate origin is a starting touch point of the touch track, an X axis extends from west to east, and a Y axis extends from south to north, and the processing unit determines the touch direction value according to the Descartes coordinate system and the touch track.

3. The portable electronic device as described in claim 1, wherein the processing unit is configured to compare the touch direction value with the at least one relative orientation value to determine which of the at least one external portable electronic device the portable electronic device will transmit the selected data to as follows: the processing unit determines that the portable electronic device will transmit the selected data to one of the at least one external portable electronic device if a difference between the relative orientation value associated with the one of the at least one external portable electronic device and the touch direction value is within a preset value range and the difference is less than any difference between the relative orientation value associated with any of the remaining of the at least one external portable electronic device and the touch direction value.

4. The portable electronic device as described in claim 1, wherein the processing unit is configured to compare the touch direction value with the at least one relative orientation value to determine which of the at least one external portable electronic device the portable electronic device will transmit the selected data to as follows: if a difference between the orientation value associated with one of the at least one external electronic device and the direction value is equal to a difference between the orientation value associated with another one of the at least one external electronic device and the direction value and the two differences are within a preset value range, the processing unit is further configured to obtain a distance value between the one of the at least one external electronic device and the portable electronic device and a distance value between the another one of the at least one external electronic device and the portable electronic device, and further configured to determine that the portable electronic device will transmit the selected data to the external electronic device the distance value between which and the portable electronic device is greater.

5. The portable electronic device as described in claim 1, wherein the processing unit is configured to compare the touch direction value with the at least one relative orientation value to determine which of the at least one external portable electronic device the portable electronic device will transmit the selected data to as follows: if a difference between the orientation value associated with one of the at least one external electronic device and direction value is equal to a difference between the orientation value associated with another one of the at least one external electronic device and direction value and the two differences are within a preset value range, the processing unit is further configured to obtain a distance value between the one of the at least one external electronic device and the portable electronic device and a distance value between the another one of the at least one external electronic device and the portable electronic device, and further configured to determine that the portable electronic device will transmit the selected data to the external electronic device the distance value between which and the portable electronic device is less.

6. The portable electronic device as described in claim 1, wherein the processing unit is further configured to determine that the touch operation is an invalid operation if a difference between the touch direction value and any of the at least one relative orientation value does not fall within a preset value range.

7. The portable electronic device as described in claim 1, wherein the touch-sensitive unit is a touch-sensitive display.

8. The portable electronic device as described in claim 1, wherein the touch-sensitive unit is a touch pad.

9. A data transmission method applied in a portable electronic device, the portable electronic device comprising a touch-sensitive unit, the data transmission method comprising:
obtaining at least one relative orientation value of at least one external portable electronic device relative to the portable electronic device;
determining touched touch points of the touch-sensitive unit and a touch track according to the touched touch points once a touch operation occurs;
determining a touch direction value according to the touch track;
comparing the touch direction value with the at least one relative orientation value to determine which of the at least one external portable electronic device the portable electronic device will transmit selected data to; and
transmitting the selected data to the determined external portable electronic device.

10. The data transmission method as described in claim 9, wherein the step of comparing the touch direction value with the at least one relative orientation value to determine which of the at least one external portable electronic device the portable electronic device will transmit selected data to comprising:
determining that the portable electronic device will transmit the selected data to one of the at least one external portable electronic device if a difference between the relative orientation value associated with the one of the at least one external portable electronic device and the touch direction value is within a preset value range and the difference is less than any difference between the relative orientation value associated with any of the remaining of the at least one external portable electronic device and the touch direction value.

11. The data transmission method as described in claim 9, wherein the step of comparing the touch direction value with the at least one relative orientation value to determine which of the at least one external portable electronic device the portable electronic device will transmit selected data to comprising:
obtaining a distance value between one of the at least one external electronic device and the portable electronic device and a distance value between another one of the at least one external electronic device and the portable electronic device if a difference between the orientation value associated with the one of the at least one external electronic device and the direction value is equal to a difference between the orientation value associated with the another one of the at least one external electronic device and the portable electronic device and the two differences are within a preset value range; and
determining that the portable electronic device will transmit the selected data to the external electronic device the distance value between which and the portable electronic device is greater.

12. The data transmission method as described in claim 9, wherein the step of comparing the touch direction value with the at least one relative orientation value to determine which of the at least one external portable electronic device the portable electronic device will transmit selected data to comprising:
obtaining a distance value between one of the at least one external electronic device and the portable electronic device and a distance value between another one of the at least one external electronic device and the portable electronic device if a difference between the orientation value associated with the one of the at least one external electronic device and the portable electronic device is equal to a difference between the orientation value associated with the another one of the at least one external electronic device and the portable electronic device and the two differences are within a preset value range; and
determining that the portable electronic device will transmit the selected data to the external electronic device the distance value between which and the portable electronic device is greater.

13. The data transmission method as described in claim 9 further comprising:
determining that the touch operation is an invalid operation if a difference between any of the at least one external portable electronic device and the touch direction value does not fall within a preset value range.
